(19) United States
(12) Patent Application Publication
(10) Pub. No.: US 2009/0126473 A1
(43) Pub. Date: May 21, 2009

(54) Method and device to indicate the content of garbage cans and vessels

(76) Inventors: Shai Porat, Bet Shemesh (IL); Uzi Ezra Havosha, Tel Aviv (IL); Gedalia Shvarzman, Bet Shemesh (IL); Elad Katan, Bet Shemesh (IL)

Correspondence Address: UZI EZRA HAVOSHA & PARTNERS, HADAR-DAFNA HOUSE 39 SHAOUL HAMELECH STREET, TEL AVIV, 64928, IL

(21) Appl. No.: 11/986,047

(22) Filed: Nov. 20, 2007

(51) Int. Cl. G01F 17/00; G08B 5/00; G08B 5/36

(52) U.S. Cl. 73/149; 220/694; 340/815.4; 340/815.67

(57) ABSTRACT

A means to measure the content of vessels and relay that information to persons remote from the vessels. The means to measure could be for example volume sensors, photo-detectors or lasers. The relay of information could be for example, wires or wirelessly. The specific use of this innovation with garbage cans. Display of lights on the garbage can will indicate the volume of garbage in the garbage can. Another embodiment calls for wireless transmission of the volume information to a remote receiver that is translated to a readily readable format so that garbage collectors may see remotely which garbage cans to empty and which may be left until the following collection.

### FIELD OF THE INVENTION

This invention is in the field of content indicators with specific reference herein to the application to garbage cans.

### BACKGROUND OF THE INVENTION

Knowledge of the volume of content of a closed vessel is a useful tool where the fullness or emptiness of the vessel is necessary to know. When a vessel is nearly empty an indicator would show that it requires filling. This specification describes this invention as it applies to the content of garbage cans. Garbage collectors would like to know how much garbage is in a garbage can because if it is close to empty they could skip that garbage can that time and empty it the next time they work in that street. At present the garbage collectors have to go to every garbage can and open the covering to inspect the content.

Alternately the garbage collectors do not spend time deciding whether or not to empty the garbage can as they have already stopped their vehicle, the garbage truck, and walked to the garbage can. It would be a waste of time to leave the garbage can after having removed the covering to inspect the contents, so the garbage collectors usually take every garbage can and prepare all of them for emptying regardless of their content. This procedure wastes the time of the garbage collectors and the time of the garbage truck. The garbage collectors have to bring each garbage can to a position where the garbage truck can have the garbage can attached to the truck and the truck then tips the garbage can upside-down shakes it to loosen the last few contents and the returns the garbage can to the ground with the upper end upward ready to be wheeled or dragged back to the designated place of the garbage can.

The raising and lowering mechanisms of garbage trucks usually work with hydraulic oil pressure systems and each garbage can that is emptied takes a standard range of time. If less garbage cans were handled the saving in manpower and truck time could be considerable. This saving is a monetary saving as the same job is finished quicker. This could extrapolate in a calculation for a city to a saving of the number of garbage trucks and the corresponding manpower that are needed to work with the truck. Alternatively, the same team of garbage collectors and the same garbage truck could cover a greater area in the same amount of time.

Another way of measuring the increase in efficiency could be that the garbage trucks would cover the same area but do so faster and be ready to start the cycle again quicker than previously thereby offering a better and healthier service to the public. This would be particularly important where the local authority or company organizing the garbage collecting does not manage to empty certain garbage cans before the garbage overflows while others are hardly used. Overfull garbage cans cause a number of problems like, being a health hazard, causing the garbage collectors to spend time manually collecting the fallen garbage, stray cats and other wild animals more easily enter the garbage cans in search of food and pull garbage that was in the cans onto the floor which often is a sidewalk or other area where people walk and spilled garbage is an unsightly and odorous problem that lowers the moral of local residents, encourages people to be careless with keeping the area clean and tidy and can adversely affect the value of property in that neighborhood. For all these reasons, more frequent emptying of the garbage cans would be a positive factor. Economic factors are often the reason why authorities do not purchase more trucks and employ the accompanying teams of garbage collectors in order to avoid the above well-known hazards. This invention enables more frequent emptying of garbage cans without increasing the number of trucks and amount of manpower.

### SUMMARY OF THE INVENTION

It is to be understood that both the foregoing general description and the following detailed description present embodiments of the invention and are intended to provide an overview or framework for understanding the nature and character of the invention as it is claimed. The accompanying drawings are included to provide a further understanding of the invention and are incorporated into and constitute a part of this specification. The drawings illustrate various embodiments of the invention and, together with the description, serve to explain the principles and operations of the invention but not to limit the invention to these descriptions only.

The object of this invention is to have a way of indicating from a distance the volume of content in a vessel or container.

Another object of this invention is to apply the invention specifically to garbage cans and garbage collecting.

The way of indicating the content of the garbage can could be with lights that show to the garbage collectors the volume of garbage inside the can. There could be different colored lights where certain colors represent the status of the volume of garbage inside the garbage can. For example, a green light could indicate very little garbage and the garbage collectors could move onto the next garbage can; an orange light could indicate a medium volume of garbage and the garbage collectors could have a formula like for example, if the next time the collect garbage in that area is in two days then the garbage can with the orange light could be left until the next time but if the next collection is after two days the that garbage can would be emptied. A red light could indicate for example, a garbage can that is at least three quarters full and would definitely need to be emptied.

Other methods of indicating the content volume in a garbage can could be a group of lights not necessarily colored but where their position would indicate the content volume. This could be say three lights in a protective frame in vertical formation where the lowest one could indicate that the volume of garbage is low and the highest light would indicate much garbage.

Alternatively the lights could be positioned at different heights on the garbage bin. If only the light near the base of the garbage shines then the content volume is low. If the top light or all three lights are alight the content volume is high. Another method of indicating the content volume could be a screen of lights like led lights, or a liquid crystal type screen that would indicate using words like “empty” “full” or using numbers from one to three or from one to ten to indicate the content volume.

Another method of indicating content volume could be for the volume detectors or sensors to be in the garbage can and the screen or other method of indication could be situated in the garbage truck. This would save duplicating apparatus like lights and their supportive energy source in each garbage can. It would also protect this part of the apparatus from damage. There would need to be a method of wireless communication from the garbage can to the garbage truck.

The method used to indicate the content volume in the garbage can would depend amongst other factors on the source of electrical power available, the vulnerability of the apparatus and the risk of damage to the apparatus during the garbage emptying process, capital and maintenance costs and the like.

There could be more than one alternative methods used to measure the volume of garbage in a garbage can. There could be a volume sensor that would detect the volume of garbage and relay the resultant information to the relevant light or other indicating method. There could be a volume sensor connected to each light or other indicating method. An alternative method of detecting volume could be an electronic eye or a laser beam. When the line of the light of the electronic eye or the beam of the laser is broken that would indicate that the garbage has reached the level of that sensor.

The energy to operate the methods and apparatus of this invention could be supplied by batteries that are replaceable or rechargeable. In countries that have enough exposure to sunlight a solar panel could be used to charge a battery that would supply the necessary electrical energy.

A more sophisticated method of operating this invention could be for the power used to indicate content volume and transmit information to operate only when the garbage truck in within a given proximity to the garbage can. A certain wavelength frequency transmitted by the truck would cause the content sensors to transmit back to the receiver in the truck the current content situation. This transmitting feature on the truck could be used to operate the light indicators on the garbage cans when the truck is in close proximity to the garbage cans in order to save electrical power.

A transmitter in the garbage truck could send a signal to the apparatus in the garbage can that would cause the positioned sensors in the garbage bin to respond by transmitting the content volume status to the receiver in the truck which would be translated by a microprocessor to indicate on a screen in the garbage truck. Where more than one garbage can is in close proximity with each other there would need to be a method of identification which garbage can is indicating which content volume, for example there could be number identification on each garbage can in that group.

Another feature of this invention is to enable a garbage can that is situated behind a wall, door or other protective or aesthetic covering to have its content volume to be indicated on the wall, door and the like. Many times people wish to hide the unsightly scene and odor of garbage cans by building an enclosed area with a wall or a door facing the adjacent pathway or road. The garbage cans are not visible from the road access. In this case the garbage collectors would not be able to see the indicator lights. Other indication methods may still work like for example, the method of direct transmission from the volume sensor to a receiver, microprocessor and screen in the garbage truck. If more than one garbage can is in such an enclosed area, the garbage cans could be numbered corresponding to the number situated close to the indicator lights on the wall or door of the enclosed area.

### BRIEF DESCRIPTION OF THE DRAWINGS

The accompanying drawings, which are incorporated in and form a part of this specification, illustrate embodiments of the invention and together with the description, serve to explain by way of example only, the principles of the invention:

FIG. 1 is a schematic depiction of a garbage can of this invention.

FIG. 2 is a schematic depiction of a garbage can with transmitting sensors.

FIG. 3 is a schematic depiction in plan view of a group of garbage cans in an enclosed area.

FIG. 4 is a schematic depiction of side view of the enclosure wall and door.

### DETAILED DESCRIPTION OF THE PREFERRED EMBODIMENTS

As will be appreciated the present invention is capable of other and different embodiments than those discussed above and described in more detail below, and its several details are capable of modifications in various aspects, all without departing from the spirit of the invention.

Accordingly, the drawings and description of the embodiments set forth below are to be regarded as illustrative in nature and not restrictive.

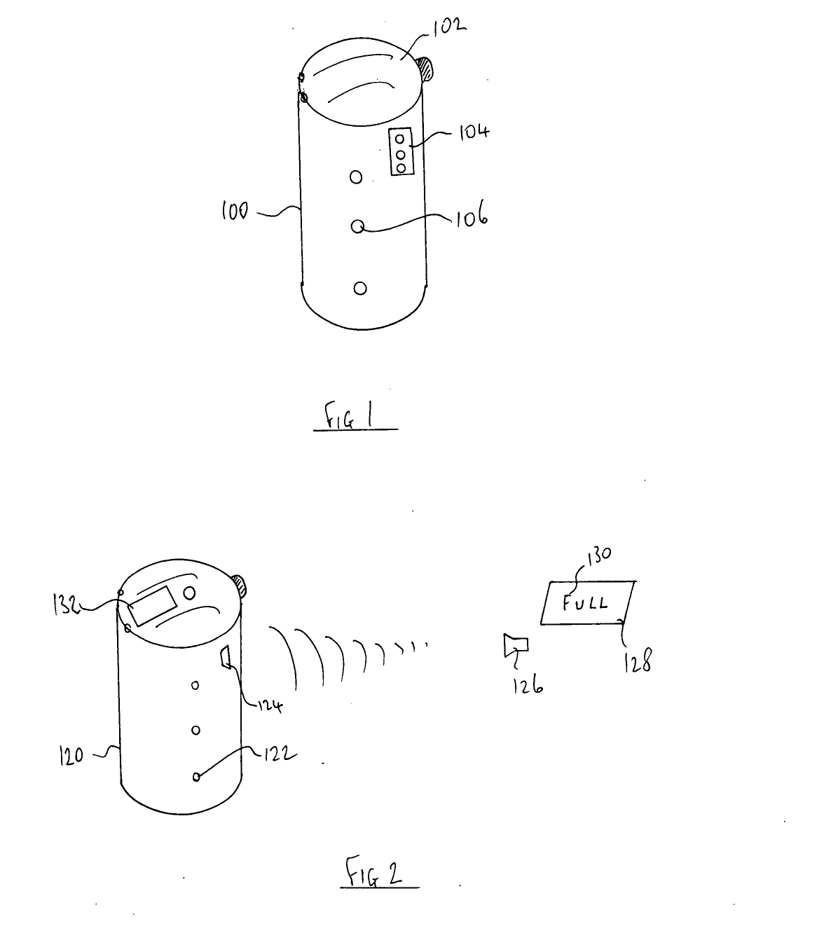

FIG. 1 shows a garbage can 100 with a hinged lid cover 102. There are three lights 104, optionally colored, in a frame that represent the three content states of “empty”, “half” and “full”.

Alternately, the lights could be embedded into the wall of the garbage can 100 at the height of the garbage inside the can 100 so that when the can 100 is half full of garbage the middle light 106 would shine as the result of a content sensor inside the can 100 detecting the height of the garbage.

The lights 104 or those in the wall of the can 100 could be placed at more than one position around the circumference of the garbage can 100 so that even if the can 100 were turned around, a set of lights would be visible to the approaching garbage collectors.

FIG. 2 shows a garbage can 120 with electronic eyes 122 placed at different heights. When an eye 122 detects that garbage has reached the height of that eye there would be a transmission of this fact via the transmitter 124 to the receiver 126 that could be in the garbage truck. There could be a screen 128 in the truck and a microprocessor that would convert the transmissions to a symbol or word 130 on the screen to indicate to the garbage collectors the status of the garbage in that garbage can 120.

The electrical power required to make the various electrical parts operate could be from a battery. The battery could be replaceable, rechargeable by charging from the mains electricity or rechargeable from a solar panel 132.

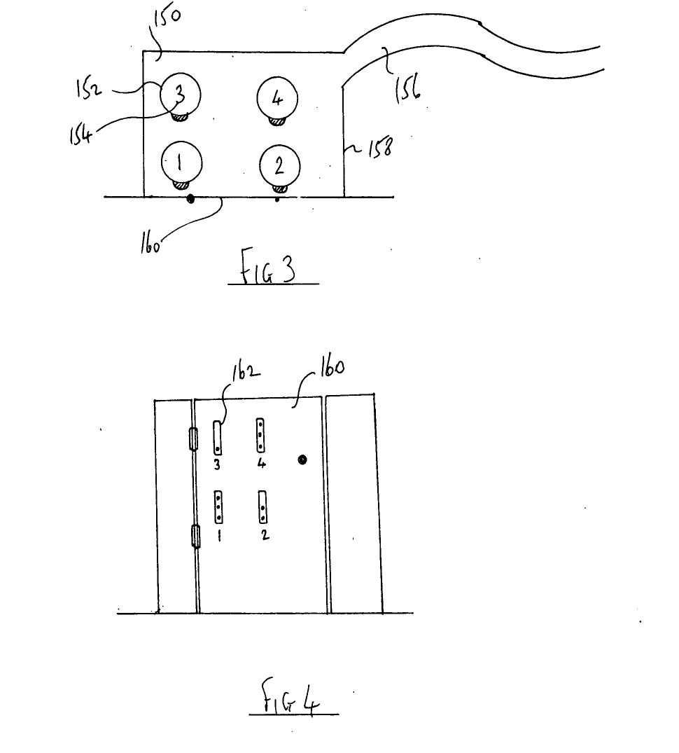

FIG. 3 shows how this invention would work in the situation where more than one garbage can is in close proximity. Often this occurs when the garbage cans are enclosed in an area for aesthetic purposes. FIG. 3 shows the plan view of such an area 150 with four garbage cans 152 each with a number 154 clearly visible thereon. A common structure for such an area of garbage bins would have access for users 156, walls 158 around the area and a hinged door 160 facing the frontage giving access to the garbage collectors. The garbage cans 152 would have content sensors as described in relation to FIG. 1 and FIG. 2 but optionally would not have visual indicators like the lights FIG. 1 106 because the garbage collectors view of the garbage cans would be obscured by the wall 158 and door 160.

FIG. 4 shows the side of the same enclosed area that has the frontal access door 160. On the door 160 are four sets of lights 162 corresponding to the four garbage cans FIG. 3 152 and are numbered accordingly. The lights in each set of lights 162 would light according to the content sensors in the garbage cans FIG. 3 152. Each of those sensors would transmit a different frequency when it detects that garbage has reached the height of the sensor and the corresponding light would shine on the sets of lights on the door 160. FIG. 4 shows the situation where the garbage collectors would see that there are at least two garbage cans namely number 1 and number 4 that are close to full of garbage and need emptying.

What is claimed:

1. A method and device for a vessel content indicator comprising,
a. a means to indicate externally what is the volume of the contents inside the said vessel,
b. a means to measure the internal content volume of the said vessel, and
c. a means to communicate the said measurement of internal content to the said external indication means,
whereby the volume of content of a vessel is indicated externally.

2. A method and device for a vessel content indicator as claimed in claim 1 wherein the said external indication is lights.

3. A method and device for a vessel content indicator as claimed in claim 2 wherein the said lights are colored where different colors represent different volumes of contents.

4. A method and device for a vessel content indicator as claimed in claim 2 wherein the said lights are positioned in such a way that the position of one said light relative to the position of another said light indicates the said content volume.

5. A method and device for a vessel content indicator as claimed in claim 4 wherein the said lights are positioned on the wall of the said vessel in such a way that the position of the said light on the said wall indicates the said content volume.

6. A method and device for a vessel content indicator as claimed in claim 1 wherein the said external indication is displayed on a screen.

7. A method and device for a vessel content indicator as claimed in claim 1 wherein the said measurement is made with a volume sensor.

8. A method and device for a vessel content indicator as claimed in claim 1 wherein the said measurement is made with an optic-electronic device, like a photo-detector whose optic beam is broken by the said contents of the said vessel.

9. A method and device for a vessel content indicator as claimed in claim 8 wherein the said measurement is made with a laser.

10. A method and device for a vessel content indicator as claimed in claim 1 further comprising a wireless communication between the said vessel and an external receiver and display device whereby when the said external object is in a given proximity to the said vessel the volume content of the said vessel is transmitted to the said receiver and display device.

11. A method and device for a garbage can content indicator comprising,
a. indicator lights on the said garbage can to indicate the volume of garbage in the said garbage can,
b. a volume sensor in the said garbage can,
c. a source of electrical energy,
d. a connection between the said volume sensor and the said lights,
whereby the said lights would indicate the degree of content volume of garbage in the said garbage can.

12. A method and device for a garbage can content indicator as claimed in claim 11 wherein the said lights indicate the said content volume by means of color.

13. A method and device for a garbage can content indicator as claimed in claim 11 wherein the said lights are positioned in such a way that the position of one said light relative to the position of another said light indicates the said content volume.

14. A method and device for a garbage can content indicator as claimed in claim 11 wherein the said source of energy is solar energy.

15. A method and device for a garbage can content indicator as claimed in claim 11 wherein the said indicator lights are on a wall or screen separating the said garbage cans from view.

16. A method and device for a garbage can content indicator as claimed in claim 11 wherein the said garbage cans are identified by an identification number.

17. A method and device for a garbage can content indicator comprising,
a. at least one volume sensor in the said garbage can,
b. a source of electrical energy,
c. a transmitter to transmit the volume information from the said volume sensor to a remote receiver,
d. a remote receiver to receive the said volume information from the said transmitter,
e. a microprocessor to transform the information from the receiver to an interface to display the said content volume,
whereby garbage collectors could remotely identify the volume of garbage in garbage cans.

18. A method and device for a garbage can content indicator as claimed in claim 15 wherein the said volume sensor is an optic-electronic device, like a photo-detector whose optic beam is broken by the said contents of the said garbage can.

19. A method and device for a garbage can content indicator as claimed in claim 15 wherein the said volume sensor wherein the said measurement is made with a laser.

20. A method and device for a garbage can content indicator as claimed in claim 15 wherein the said garbage cans are identified by an identification number.
